(19) United States
(12) Patent Application Publication
(10) Pub. No.: US 2026/0175235 A1
(43) Pub. Date: Jun. 25, 2026

(54) METHOD FOR FULL-PARTICLE SIZE FLOTATION OF SLIME-CONTAINING LEPIDOLITE ORE

(71) Applicant: Kunming University of Science and Technology, Kunming City (CN)

(72) Inventors: Qicheng FENG, Kunming City (CN); Yanyu TANG, Kunming City (CN); Shuming WEN, Kunming City (CN); Guang HAN, Kunming City (CN); Wenhang YANG, Kunming City (CN); Youzhen NIE, Kunming City (CN)

(21) Appl. No.: 19/238,514

(22) Filed: Jun. 15, 2025

(30) Foreign Application Priority Data
Dec. 20, 2024 (CN) 202411886825.8

(51) Int. Cl. B03D 1/018; B03D 1/02; C22B 1/24; C22B 26/12

(52) U.S. Cl. CPC B03D 1/018; B03D 1/02; C22B 1/24; C22B 26/12; B03D 2201/02; B03D 2201/04; B03D 2203/04

(57) ABSTRACT

A method for full-particle size flotation of slime-containing lepidolite ore is provided. The method includes: mixing a compound regulator and the slime-containing lepidolite ore, subjecting an obtained mixture to ball milling, and adding water and conditioning; adding a compound inhibitor and a compound collector in sequence to a resulting slime-containing lepidolite ore pulp, and conducting a primary rougher; adding the compound inhibitor and the compound collector in sequence to a resulting primary rougher tailing, and conducting a secondary rougher; adding the compound inhibitor and the compound collector in sequence to a resulting secondary rougher tailing, and conducting scavenger; combining a resulting primary rougher concentrate and a resulting secondary rougher concentrate, adding the compound inhibitor to a resulting mixed rougher concentrate, and conducting a primary cleaner; subjecting a resulting primary cleaner concentrate to a secondary cleaner; regarding a resulting secondary cleaner concentrate as a lithium flotation concentrate.

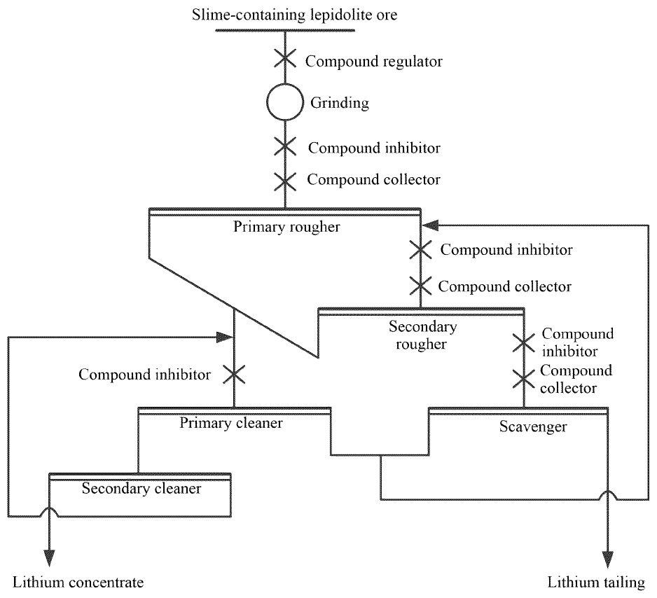

### CROSS REFERENCE TO RELATED APPLICATION

This patent application claims the benefit and priority of Chinese Patent Application No. 202411886825.8 filed with the China National Intellectual Property Administration on Dec. 20, 2024, the disclosure of which is incorporated by reference herein in its entirety as part of the present application.

### TECHNICAL FIELD

The present disclosure relates to a method for full-particle size flotation of slime-containing lepidolite ore, which belongs to the technical field of mineral processing.

### BACKGROUND

Lithium, as a strategically critical rare metal, finds extensive applications in new energy, advanced materials, and information technology sectors. While China possesses globally significant lithium reserves with relatively diverse resource types, the supply capacity of lithium raw materials in China remains insufficient due to technological and economic constraints coupled with rapid industry development. This results in long-term import dependence and high external reliance. Therefore, efficient exploitation and utilization of abundant lithium mineral resources becomes imperative to meet growing demand and alleviate excessive dependency on foreign supplies.

Lepidolite, a common valuable lithium mineral, exists as potassium-lithium aluminosilicate typically associated with quartz, feldspar, and other gangue minerals, primarily occurring in granite pegmatites. Weathering effects in lepidolite ores generate raw slime content, while subsequent mining, transportation, crushing, and grinding processes produce secondary slime. These highly active slimes readily adsorb flotation reagents, leading to dual challenges: excessive reagent consumption and increased separation difficulty between the lepidolite and the gangue minerals. This complicates flotation control and disrupts production continuity. Current mineral processing plants adopt desliming-flotation techniques for slime-containing lepidolite ores. Although improved flotation index could be achieved post-desliming, significant quantities of lepidolite ore residues remain in discarded slimes. Existing technologies fail to effectively recover the lepidolite in the slime, resulting in substantial lithium metal losses.

Consequently, it has emerged as a critical bottleneck requiring urgent resolution in the lithium industry by developing an economically viable and efficient flotation recovery method for slime-containing lepidolite ores without desliming.

### SUMMARY

To address challenges such as severe lithium loss in desliming flotation processes and poor index in non-desliming flotation for slime-containing lepidolite ore, the present disclosure provides a method for full-particle size flotation of the slime-containing lepidolite ore. This method employs a synergistic combination of a compound regulator, a compound inhibitor, and a compound collector to achieve multi-dimensional regulation across grinding, conditioning, and collection of ore. This method, without changing conventional flotation workflows, utilizes synergistic effects between flotation reagents to avoid the deteriorating effect of slime on flotation. This method enables comprehensive recovery of the slime-containing lepidolite ore through full-particle size flotation without requiring desliming.

The present disclosure provides a method for full-particle size flotation of slime-containing lepidolite ore, including the following steps:
(1) thoroughly mixing a compound regulator and the slime-containing lepidolite ore, subjecting an obtained mixture to ball milling until a lepidolite monomer is dissociated, and adding water and conditioning until a concentration of an obtained pulp reaches 32% to 42% by mass, to obtain a slime-containing lepidolite ore pulp;
(2) adding a compound inhibitor and a compound collector in sequence to the slime-containing lepidolite ore pulp obtained in step (1), and conducting a primary rougher to obtain a primary rougher concentrate and a primary rougher tailing;
(3) adding the compound inhibitor and the compound collector in sequence to the primary rougher tailing obtained in step (2), and conducting a secondary rougher to obtain a secondary rougher concentrate and a secondary rougher tailing;
(4) adding the compound inhibitor and the compound collector in sequence to the secondary rougher tailing obtained in step (3), and conducting scavenger to obtain a scavenger concentrate and a scavenger tailing, where the scavenger concentrate is conditioned and returned to the secondary rougher;
(5) combining the primary rougher concentrate obtained in step (2) and the secondary rougher concentrate obtained in step (3) to obtain a mixed rougher concentrate, adding the compound inhibitor to the mixed rougher concentrate, and conducting a primary cleaner to obtain a primary cleaner concentrate and a primary cleaner tailing, where the primary cleaner tailing is conditioned and returned to the secondary rougher;
(6) subjecting the primary cleaner concentrate obtained in step (5) to a secondary cleaner to obtain a secondary cleaner concentrate and a secondary cleaner tailing, where the secondary cleaner tailing is conditioned and returned to the primary cleaner; and
(7) regarding the secondary cleaner concentrate obtained in step (6) as a lithium flotation concentrate, while regarding the scavenger tailing obtained in step (4) as a lithium flotation tailing; where
the compound regulator is a mixture of triethanolamine (TEA) and TEA dodecylbenzenesulfonate, the compound inhibitor is a mixture of a phosphonocarboxylic acid copolymer, aminotrimethylene phosphonic acid (ATMP), and sodium carbonate, and the compound collector is a mixture of dodecylamine acetate, sodium coco sulfate (SCS), and disodium lauryl sulfosuccinate (DLS).

In some embodiments, in step (1), a mass percentage content of Li₂O in the slime-containing lepidolite ore is in a range of 0.26% to 0.64%.

In some embodiments, in terms of each ton of the slime-containing lepidolite ore, 200 g to 400 g of the compound regulator is added to a ball mill in step (1).

In some embodiments, in terms of each ton of the slime-containing lepidolite ore, 400 g to 800 g of the compound inhibitor and 240 g to 360 g of the compound collector are added for conducting the primary rougher flotation in step (2).

In some embodiments, in terms of each ton of the slime-containing lepidolite ore, 200 g to 400 g of the compound inhibitor and 120 g to 180 g of the compound collector are added for conducting the secondary rougher in step (3).

In some embodiments, in terms of each ton of the slime-containing lepidolite ore, 100 g to 200 g of the compound inhibitor and 60 g to 90 g of the compound collector are added for conducting the scavenger in step (4).

In some embodiments, in terms of each ton of the slime-containing lepidolite ore, 50 g to 100 g of the compound inhibitor is added for conducting the primary cleaner in step (5).

In some embodiments, taking a mass of the compound regulator as 100%, the TEA accounts for 60% to 80% and the TEA dodecylbenzenesulfonate accounts for 20% to 40%.

In some embodiments, taking a mass of the compound inhibitor as 100%, the phosphonocarboxylic acid copolymer accounts for 10% to 30%, the ATMP accounts for 20% to 40%, and the sodium carbonate accounts for 40% to 60%.

In some embodiments, taking a mass of the compound collector as 100%, the dodecylamine acetate accounts for 35% to 45%, the SCS accounts for 40% to 50%, and the DLS accounts for 10% to 20%.

Some embodiments of the present disclosure have the following beneficial effects.

(1) The present disclosure fully leverages synergistic effects among flotation reagents, implementing multi-dimensional regulation across an entire process of grinding, conditioning, and collection for slime-containing lepidolite ore. The present disclosure economically and efficiently resolves problems including severe lithium loss in desliming-flotation processes and poor index in non-desliming processes, achieving full-particle size flotation recovery of the slime-containing lepidolite ore. The present disclosure establishes a novel pathway for efficient separation and enrichment of complex refractory lithium mineral resources.

(2) After a compound regulator in the present disclosure is adsorbed on surfaces of ore particles, surface energy of the ore particles could be reduced, so that lattice positions of a surface layer of the ore particles are migrated to produce defects, thereby decreasing hardness and mechanical strength of the ore particles. Simultaneously, the compound regulator enhances the dispersion effect of the ore particles, preventing adhesion of the ore particles to grinding media and agglomeration between the ore particles, thus improving grinding efficiency, optimizing a composition of grinding particle size, and reducing further sliming of ore.

(3) A compound inhibitor in the present disclosure could selectively adsorb on surfaces of gangue minerals, reduce reactivity of the gangue minerals with collectors and hinder hydrophobic effect of the collectors on the surface of the gangue minerals, thereby increasing flotation differentiation between lepidolite and the gangue minerals in the ore, improving separation index of lepidolite ore, and economically and efficiently resolving problems including similar surface properties between the lepidolite and the gangue minerals, narrow floatability differences, and separation difficulties.

(4) A compound collector in the present disclosure could selectively adsorb on surfaces of the lepidolite, intensifying hydrophobicity on the surfaces of the lepidolite. Simultaneously, synergistic interactions produced by combined use of the compound collector, the compound regulator and the compound inhibitor could be used to target regulation of mineral surface properties and pulp environment, optimize flotation froth structure and mineral-bearing capacity, resolve problems including foam control and slime suppression during lepidolite ore flotation, and facilitate a smooth flotation process.

### BRIEF DESCRIPTION OF THE DRAWINGS

FIGURE shows a process flow chart according to an embodiment of the present disclosure.

### DETAILED DESCRIPTION OF THE EMBODIMENTS

The present disclosure will be further described in detail below in conjunction with specific implementations. However, the scope of the present disclosure is not limited thereto.

In the following examples of the present disclosure, a compound regulator is a mixture of TEA and TEA dodecylbenzenesulfonate, a compound inhibitor is a mixture of a phosphonocarboxylic acid copolymer, ATMP, and sodium carbonate, and a compound collector is a mixture of dodecylamine acetate, SCS, and DLS.

Example 1: in this example, taking a mass of the compound regulator as 100%, the TEA accounted for 60% and the TEA dodecylbenzenesulfonate accounted for 40%; taking a mass of the compound inhibitor as 100%, the phosphonocarboxylic acid copolymer accounted for 20%, the ATMP accounted for 40%, and the sodium carbonate accounted for 40%; and taking a mass of the compound collector as 100%, the dodecylamine acetate accounted for 35%, the SCS accounted for 45%, and the DLS accounted for 20%.

As shown in FIGURE, a method for full-particle size flotation of slime-containing lepidolite ore was performed as follows.

(1) The compound regulator was thoroughly mixed with the slime-containing lepidolite ore, an obtained mixture was subjected to ball milling in a ball mill until a lepidolite monomer was dissociated, and water was added and conditioning was conducted until an obtained pulp with a concentration of 32% by mass, to obtain a slime-containing lepidolite ore pulp, where in terms of each ton of the slime-containing lepidolite ore, 200 g of the compound regulator was added to the ball mill, and a mass percentage content of Li₂O in the slime-containing lepidolite ore was 0.26%.

(2) The compound inhibitor and the compound collector were added in sequence to the slime-containing lepidolite ore pulp obtained in step (1), and a resulting pulp mixture was subjected to a primary rougher to obtain a primary rougher concentrate and a primary rougher tailing, where in terms of each ton of the slime-containing lepidolite ore, 400 g of the compound inhibitor and 240 g of the compound collector were added to the slime-containing lepidolite ore pulp for the primary rougher.

(3) The compound inhibitor and the compound collector were added in sequence to the primary rougher tailing obtained in step (2), and a resulting pulp mixture was subjected to a secondary rougher to obtain a secondary rougher concentrate and a secondary rougher tailing, where in terms of each ton of the slime-containing lepidolite ore, 200 g of the compound inhibitor and 120 g of the compound collector were added to the primary rougher tailing for the secondary rougher.

(4) The compound inhibitor and the compound collector were added in sequence to the secondary rougher tailing obtained in step (3), and a resulting pulp mixture was subjected to scavenger to obtain a scavenger concentrate and a scavenger tailing, where the scavenger concentrate was conditioned and returned to the secondary rougher, and in terms of each ton of the slime-containing lepidolite ore, 100 g of the compound inhibitor and 60 g of the compound collector were added to the secondary rougher tailing for the scavenger.

(5) The primary rougher concentrate obtained in step (2) and the secondary rougher concentrate obtained in step (3) were combined, the compound inhibitor was added to an obtained mixed rougher concentrate, and a resulting mixture was subjected to a primary cleaner to obtain a primary cleaner concentrate and a primary cleaner tailing, where the primary cleaner tailing was conditioned and returned to the secondary rougher, and in terms of each ton of the slime-containing lepidolite ore, 50 g of the compound inhibitor was added to the mixed rougher concentrate for the primary cleaner.

(6) The primary cleaner concentrate obtained in step (5) was subjected to a secondary cleaner to obtain a secondary cleaner concentrate and a secondary cleaner tailing, where the secondary cleaner tailing was conditioned and returned to the primary cleaner.

(7) The secondary cleaner concentrate obtained in step (6) was regarded as a lithium flotation concentrate, while the scavenger tailing obtained in step (4) was regarded as a lithium flotation tailing.

In this example, a flotation recovery of lithium is 83.6%.

Example 2: in this example, taking a mass of the compound regulator as 100%, the TEA accounted for 70% and the TEA dodecylbenzenesulfonate accounted for 30%; taking a mass of the compound inhibitor as 100%, the phosphonocarboxylic acid copolymer accounted for 30%, the ATMP accounted for 20%, and the sodium carbonate accounted for 50%; and taking a mass of the compound collector as 100%, the dodecylamine acetate accounted for 40%, the SCS accounted for 50%, and the DLS accounted for 10%.

As shown in FIGURE, a method for full-particle size flotation of a slime-containing lepidolite ore was performed as follows:

(1) The compound regulator was thoroughly mixed with the slime-containing lepidolite ore, an obtained mixture was subjected to ball milling in a ball mill until a lepidolite monomer was dissociated, and water was added and conditioning was conducted until an obtained pulp with a concentration of 37% by mass, to obtain a slime-containing lepidolite ore pulp, where in terms of each ton of the slime-containing lepidolite ore, 300 g of the compound regulator was added to the ball mill, and a mass percentage content of Li₂O in the slime-containing lepidolite ore was 0.45%.

(2) The compound inhibitor and the compound collector were added in sequence to the slime-containing lepidolite ore pulp obtained in step (1), and a resulting pulp mixture was subjected to a primary rougher to obtain a primary rougher concentrate and a primary rougher tailing, where in terms of each ton of the slime-containing lepidolite ore, 600 g of the compound inhibitor and 300 g of the compound collector were added to the slime-containing lepidolite ore pulp for the primary rougher.

(3) The compound inhibitor and the compound collector were added in sequence to the primary rougher tailing obtained in step (2), and a resulting pulp mixture was subjected to a secondary rougher to obtain a secondary rougher concentrate and a secondary rougher tailing, where in terms of each ton of the slime-containing lepidolite ore, 300 g of the compound inhibitor and 150 g of the compound collector were added to the primary rougher tailing for the secondary rougher.

(4) The compound inhibitor and the compound collector were added in sequence to the secondary rougher tailing obtained in step (3), and a resulting pulp mixture was subjected to scavenger to obtain a scavenger concentrate and a scavenger tailing, where the scavenger concentrate was conditioned and returned to the secondary rougher, and in terms of each ton of the slime-containing lepidolite ore, 150 g of the compound inhibitor and 75 g of the compound collector were added to the secondary rougher tailing for the scavenger.

(5) The primary rougher concentrate obtained in step (2) and the secondary rougher concentrate obtained in step (3) were combined, the compound inhibitor was added to an obtained mixed rougher concentrate, and a resulting mixture was subjected to a primary cleaner to obtain a primary cleaner concentrate and a primary cleaner tailing, where the primary cleaner tailing was conditioned and returned to the secondary rougher, and in terms of each ton of the slime-containing lepidolite ore, 75 g of the compound inhibitor was added to the mixed rougher concentrate for the primary cleaner.

(6) The primary cleaner concentrate obtained in step (5) was subjected to a secondary cleaner to obtain a secondary cleaner concentrate and a secondary cleaner tailing, where the secondary cleaner tailing was conditioned and returned to the primary cleaner.

(7) The secondary cleaner concentrate obtained in step (6) was regarded as a lithium flotation concentrate, while the scavenger tailing obtained in step (4) was regarded as a lithium flotation tailing.

In this example, a flotation recovery of lithium is 84.8%.

Example 3: in this example, taking a mass of the compound regulator as 100%, the TEA accounted for 80% and the TEA dodecylbenzenesulfonate accounted for 20%; taking a mass of the compound inhibitor as 100%, the phosphonocarboxylic acid copolymer accounted for 10%, the ATMP accounted for 30%, and the sodium carbonate accounted for 60%; and taking a mass of the compound collector as 100%, the dodecylamine acetate accounted for 45%, the SCS accounted for 40%, and the DLS accounted for 15%.

As shown in FIGURE, a method for full-particle size flotation of a slime-containing lepidolite ore was performed as follows:

(1) The compound regulator was thoroughly mixed with the slime-containing lepidolite ore, an obtained mixture was subjected to ball milling in a ball mill until a lepidolite monomer was dissociated, and water was added and conditioning was conducted until an obtained pulp with a concentration of 42% by mass, to obtain a slime-containing lepidolite ore pulp, where in terms of each ton of the slime-containing lepidolite ore, 400 g of the compound regulator was added to the ball mill, and a mass percentage content of Li₂O in the slime-containing lepidolite ore was 0.64%.

(2) The compound inhibitor and the compound collector were added in sequence to the slime-containing lepidolite ore pulp obtained in step (1), and a resulting pulp mixture was subjected to a primary rougher to obtain a primary rougher concentrate and a primary rougher tailing, where in terms of each ton of the slime-containing lepidolite ore, 800 g of the compound inhibitor and 360 g of the compound collector were added to the slime-containing lepidolite ore pulp for the primary rougher.

(3) The compound inhibitor and the compound collector were added in sequence to the primary rougher tailing obtained in step (2), and a resulting pulp mixture was subjected to a secondary rougher to obtain a secondary rougher concentrate and a secondary rougher tailing, where in terms of each ton of the slime-containing lepidolite ore, 400 g of the compound inhibitor and 180 g of the compound collector were added to the primary rougher tailing for the secondary rougher.

(4) The compound inhibitor and the compound collector were added in sequence to the secondary rougher tailing obtained in step (3), and a resulting pulp mixture was subjected to scavenger to obtain a scavenger concentrate and a scavenger tailing, where the scavenger concentrate was conditioned and returned to the secondary rougher, and in terms of each ton of the slime-containing lepidolite ore, 200 g of the compound inhibitor and 90 g of the compound collector were added to the secondary rougher tailing for the scavenger.

(5) The primary rougher concentrate obtained in step (2) and the secondary rougher concentrate obtained in step (3) were combined, the compound inhibitor was added to an obtained mixed rougher concentrate, and a resulting mixture was subjected to a primary cleaner to obtain a primary cleaner concentrate and a primary cleaner tailing, where the primary cleaner tailing was conditioned and returned to the secondary rougher, and in terms of each ton of the slime-containing lepidolite ore, 100 g of the compound inhibitor was added to the mixed rougher concentrate for the primary cleaner.

(6) The primary cleaner concentrate obtained in step (5) was subjected to a secondary cleaner to obtain a secondary cleaner concentrate and a secondary cleaner tailing, where the secondary cleaner tailing was conditioned and returned to the primary cleaner.

(7) The secondary cleaner concentrate obtained in step (6) was regarded as a lithium flotation concentrate, while the scavenger tailing obtained in step (4) was regarded as a lithium flotation tailing.

In this example, a flotation recovery of lithium is 86.1%.

The embodiments of the present disclosure have been described in detail above, but the present disclosure is not limited to the above embodiments. Various changes can be made without departing from the concept of the present disclosure within the range of knowledge possessed by those of ordinary skill in the art.

1. A method for full-particle size flotation of slime-containing lepidolite ore, comprising the following steps:
(1) thoroughly mixing a compound regulator and the slime-containing lepidolite ore, subjecting an obtained mixture to ball milling until a lepidolite is liberated, and adding water and conditioning until a concentration of an obtained pulp reaches 32% to 42% by mass, to obtain a slime-containing lepidolite ore pulp, wherein a mass percentage content of Li₂O in the slime-containing lepidolite ore is in a range of 0.26% to 0.64%, and in terms of each ton of the slime-containing lepidolite ore, 200 g to 400 g of the compound regulator is added to a ball mill;
(2) adding a compound inhibitor and a compound collector in sequence to the slime-containing lepidolite ore pulp obtained in step (1), and conducting a primary rougher to obtain a primary rougher concentrate and a primary rougher tailing, wherein in terms of each ton of the slime-containing lepidolite ore, 400 g to 800 g of the compound inhibitor and 240 g to 360 g of the compound collector are added for conducting the primary rougher;
(3) adding the compound inhibitor and the compound collector in sequence to the primary rougher tailing obtained in step (2), and conducting a secondary rougher to obtain a secondary rougher concentrate and a secondary rougher tailing;
(4) adding the compound inhibitor and the compound collector in sequence to the secondary rougher tailing obtained in step (3), and conducting scavenger to obtain a scavenger concentrate and a scavenger tailing, wherein the scavenger concentrate is conditioned and returned to the secondary rougher;
(5) combining the primary rougher concentrate obtained in step (2) and the secondary rougher concentrate obtained in step (3) to obtain a mixed rougher concentrate, adding the compound inhibitor to the mixed rougher concentrate, and conducting a primary cleaner to obtain a primary cleaner concentrate and a primary cleaner tailing, wherein the primary cleaner tailing is conditioned and returned to the secondary rougher;
(6) subjecting the primary cleaner concentrate obtained in step (5) to a secondary cleaner to obtain a secondary cleaner concentrate and a secondary cleaner tailing, wherein the secondary cleaner tailing is conditioned and returned to the primary cleaner; and
(7) regarding the secondary cleaner concentrate obtained in step (6) as a lithium flotation concentrate, while regarding the scavenger tailing obtained in step (4) as a lithium flotation tailing; wherein
the compound regulator is a mixture of triethanolamine (TEA) and TEA dodecylbenzenesulfonate, wherein taking a mass of the compound regulator as 100%, the TEA accounts for 60% to 80% and the TEA dodecylbenzenesulfonate accounts for 20% to 40%;
the compound inhibitor is a mixture of a phosphonocarboxylic acid copolymer, aminotrimethylene phosphonic acid (ATMP), and sodium carbonate, wherein taking a mass of the compound inhibitor as 100%, the phosphonocarboxylic acid copolymer accounts for 10% to 30%, the ATMP accounts for 20% to 40%, and the sodium carbonate accounts for 40% to 60%; and
the compound collector is a mixture of dodecylamine acetate, sodium coco sulfate (SCS), and disodium lauryl sulfosuccinate (DLS), wherein taking a mass of the compound collector as 100%, the dodecylamine acetate accounts for 35% to 45%, the SCS accounts for 40% to 50%, and the DLS accounts for 10% to 20%.

2. (canceled)

3. The method for the full-particle size flotation of the slime-containing lepidolite ore of claim 1, wherein in terms of each ton of the slime-containing lepidolite ore, 200 g to 400 g of the compound inhibitor and 120 g to 180 g of the compound collector are added for conducting the secondary rougher in step (3).

4. (canceled)

5. (canceled)

6. The method for the full-particle size flotation of the slime-containing lepidolite ore of claim 1, wherein in terms of each ton of the slime-containing lepidolite ore, 100 g to 200 g of the compound inhibitor and 60 g to 90 g of the compound collector are added for conducting the scavenger in step (4).

7. The method for the full-particle size flotation of the slime-containing lepidolite ore of claim 1, wherein in terms of each ton of the slime-containing lepidolite ore, 50 g to 100 g of the compound inhibitor is added for conducting the primary cleaner in step (5).

8. (canceled)

9. (canceled)

10. (canceled)
